(19) United States
(12) Patent Application Publication
(10) Pub. No.: US 2021/0386268 A1
(43) Pub. Date: Dec. 16, 2021

(54) DOMESTIC APPLIANCE

(71) Applicant: BSH Hausgeräte GmbH, Munich (DE)

(72) Inventors: Alexander Sing, Wittislingen (DE); Roland Rieger, Rainau (DE); Andreas Reiter, Finningen (DE)

(21) Appl. No.: 17/281,603

(22) PCT Filed: Sep. 30, 2019
(86) PCT No.: PCT/EP2019/076371

§ 371 Date: Mar. 31, 2021

(30) Foreign Application Priority Data
Oct. 12, 2018 (DE) 10 2018 217 549.7

(51) Int. Cl. A47L 15/42; A47L 15/48; D06F 37/26; D06F 58/20; D06F 37/02; B32B 7/06; B32B 11/02; B32B 5/18; B32B 11/04

(52) U.S. Cl. CPC A47L 15/4209; B32B 2266/06; A47L 15/488; A47L 15/486; D06F 37/267; D06F 58/20; D06F 37/02; B32B 7/06; B32B 11/02; B32B 5/18; B32B 11/048; B32B 2307/102; B32B 2509/00; B32B 2307/304; B32B 2307/72; B32B 2266/0278; A47L 15/481

(57) ABSTRACT

A household appliance includes a functional compartment, and an insulation arrangement arranged externally on the functional compartment for thermal and/or acoustic insulation of the functional compartment. The insulation arrangement includes a first insulation element made as a single piece from a plastic material which is selected such that a surface of the first insulation element in facing relation to the functional compartment adheres to the functional compartment and is separable therefrom in a non-destructive manner. An active drying system is operably connected to the functional compartment for active drying of an item received in the functional compartment.

The present invention relates to a household appliance, in particular a household dishwasher.

Bitumen mats are applied to the washing compartment for acoustic insulation of a washing compartment of a household dishwasher. The bitumen mats can be glued, for example with the aid of a hot-melt adhesive, externally to the washing compartment. Bitumen mats of this kind have a high heat absorption capacity and convey the absorbed heat away from the washing compartment. If the portion of the surface of the washing compartment covered with the bitumen mats is reduced, the energy absorption of the household dishwasher may be reduced. This reduction of the covered surface leads to the noise emission of the household dishwasher increasing, however.

Document EP 3 092 935 A1 discloses an arrangement for thermal and acoustic insulation of a washing compartment of a household dishwasher. The arrangement comprises a first insulation element, which is adapted to thermally insulate the washing compartment, and a second insulation element, which is adapted to acoustically insulate the washing compartment. In this case, the first insulation element is arranged between the washing compartment and the second insulation element, wherein the first insulation element is foamed directly onto the washing compartment. With this arrangement, in which the acoustic insulation element is not attached directly to the washing compartment, the energy efficiency of the household dishwasher can be increased.

On the other hand, the drying capacity of a household dishwasher with thermally insulated washing compartment as explained above can be improved with the aid of an active drying system. An active drying system can comprise a fan, a door opener or a water-absorbent material. Active drying systems of this kind are described, for example, in document DE 10 2011 004 945 A1, in document WO 2006/069837 A1 or in document DE 103 53 774 A1. For example, a fan reduces the relative humidity in the washing compartment by way of air exchange. The items for washing can give off more moisture to the exchanged dry air again hereby. A water-absorbent material, such as zeolite or the like for example, reduces the relative humidity in the washing compartment. The dry air can then in turn absorb moisture given off by the wet items for washing.

Against this background, an object of the present invention consists in providing an improved household appliance, in particular an improved household dishwasher.

Accordingly, a household appliance, in particular a household dishwasher, with a functional compartment, in particular a washing compartment, a insulation arrangement provided externally on the functional compartment, in particular the washing compartment, for thermal and/or acoustic insulation of the functional compartment, in particular the washing compartment, and an active drying system for active drying of items, in particular items for washing, received in the functional compartment, in particular the washing compartment, wherein the insulation arrangement has an insulation element and wherein the insulation element is made as a single piece from a plastic material, which in a hardened and/or crosslinked state preferably has adhesive properties, so the first insulation element adheres to a surface facing the functional compartment, in particular the washing compartment, on the functional compartment, in particular the washing compartment, and can be non-destructively detached from it.

With the aid of the active drying system, satisfactory drying of the items, in particular items for washing, can always be ensured even with good thermal insulation of the functional compartment, in particular the washing compartment, with the aid of the insulation element.

In the present case, an “active drying system” should be taken to mean a drying system, which in the functional compartment, in particular the washing compartment, either actively generates a circulation of air or an exchange of air and/or actively, for example with the aid of a water-absorbent material, draws moisture from the functional compartment, in particular the washing compartment, given off by the items, in particular items for washing. Passive drying systems should be regarded as the opposite of active drying systems. With a passive drying system, for example the side walls of the functional compartment, in particular the washing compartment, which are not actively cooled, generate a temperature drop inside the functional compartment, in particular the washing compartment, by way of their energy exchange with the surroundings. This can only be created by an loss of energy at one or more side wall(s). If the walls are thermally insulated from the surroundings, however, the temperature drop is not sufficient to ensure a satisfactory drying result. A “passive drying system” should be taken to mean, in particular, a drying system, which operates without a forced circulation of air or a forced exchange of air, therefore and which also does not actively draw any moisture and/or heat from the functional compartment, in particular the washing compartment.

Preferably, the insulation element is made of the plastic material throughout. In this connection, “as a single piece” means that the insulation element has just one material, namely the above-mentioned plastic material. The functional compartment, in particular the washing compartment, is, in particular, cuboidal and comprises a base, a back wall, a ceiling, two mutually opposing side walls and a door. The insulation arrangement can be provided on the back wall, the ceiling, the side walls and/or on the door respectively. The insulation arrangement can also be provided on the base. The functional compartment, in particular the washing compartment, and the door enclose a functional interior, in particular the dishwasher interior, of the household appliance, in particular the household dishwasher. The items, in particular the items for washing, are received in the functional compartment, in particular the washing compartment. The insulation element can also be referred to as the first insulation element. The insulation element is suitable for thermally and/acoustically insulating the functional compartment, in particular the washing compartment. The insulation element can also be referred to as a thermal and/or acoustic insulation element, therefore.

In this case, “externally” means facing away from the functional compartment, in particular the washing compartment. For example, the back wall, the base, the ceiling, the side walls and/or the door each have an inner side facing the functional compartment, in particular the washing compartment, and an outer side facing away from the functional compartment, in particular the washing compartment. The insulation arrangement is provided on the respective outer side. That the insulation element can be “non-destructively” separated from the functional compartment, in particular the washing compartment should be taken to mean that the insulation element can be disconnected or removed from the functional compartment, in particular the washing compartment, without residues of the insulation element sticking to the functional compartment, in particular the washing compartment. However, slight residues can also remain on the functional compartment, in particular the washing compartment. This means that the insulation element may detach easily from the functional compartment, in particular the washing compartment, but residues can remain on the functional compartment, in particular the washing compartment. These may be removed by rubbing. In particular, the insulation element can be separated without aids, such as solvents, from the functional compartment, in particular the washing compartment. The connection between the insulation element and the functional compartment, in particular the washing compartment, can be a weakly adhering glued joint.

The plastic material can have a plurality of components, which are mixed in order to produce the insulation element and chemically react with each other in such a way that the plastic material completely cures and/crosslinks. The plastic material itself has the preferably adhesive or preferably adherent properties. In the present case, “adhesion” should be taken to mean the property of the plastic material that the surface of the insulation element, facing the functional compartment, in particular the washing compartment, interacts with an outer side of the washing compartment in such a way that the insulation element adheres to the functional compartment, in particular the washing compartment. The adhesion can be based on molecular interactions between the plastic material and the material of the functional compartment, in particular the washing compartment. Furthermore, the adhesion can also be based on physical-mechanical forces. For example, the plastic material can interlock or catch in microscopically small pores and/or indentations in the functional compartment, in particular the washing compartment. In particular, the insulation element is connected without adhesive to the functional compartment, in particular the washing compartment. As stated above, the plastic material of the insulation element itself preferably comprises adhesive or preferably adhering properties. An adhesive for connecting the insulation element to the functional compartment, in particular the washing compartment, can be dispensed with hereby. This simplifies production of the household appliance, in particular the household dishwasher, and enables improved reutilization of the materials used.

According to one embodiment, the plastic material is a polyurethane, in particular a foamed polyurethane.

The polyurethane preferably has an open-pore structure. The plastic material is compressible, therefore so on compression air can escape from the plastic material. Other suitable plastic material can also be used.

According to a further embodiment, the plastic material has viscoelastic properties.

A partially elastic, partially viscous material behavior can be referred to as “viscoelasticity”. Viscoelastic materials combine features of solids and liquid, therefore.

According to a further embodiment, the insulation arrangement has a first insulation element, which is made from the plastic material, and a second insulation element, wherein the first insulation element is arranged between the functional compartment, in particular the washing compartment, and the second insulation element.

The second insulation element is optional. The second insulation element can be used for acoustic insulation of the functional compartment, in particular the washing compartment. The second insulation element can be referred to as the acoustic insulation element. Due to the fact that the first insulation element is arranged between the functional compartment, in particular the washing compartment, and the second insulation element, the second insulation element cannot draw any heat from the washing compartment. This improves the energy efficiency of the household appliance, in particular the household dishwasher. The second insulation element is used, in particular, as a mass layer. The second insulation element improves the acoustic properties of the insulation arrangement.

According to a further embodiment, the household appliance, in particular the household dishwasher, has an energy consumption of less than 1.2 kWh/c, preferably of less than 1.0 kWh/c, more preferably of less than 0.8 kWh/c, more preferably of less than 0.7 kWh/c, more preferably of less than 0.6 kWh/c.

An energy consumption of less than 0.8 kWh/c can be achieved, in particular, with an active drying system, which uses a water-absorbent material. Energy consumptions of less than 0.7 kWh/c can be achieved, in particular, with the combination of different active drying systems.

According to a further embodiment, the active drying system has a water-absorbent material, in particular zeolite, for absorbing moisture in the functional compartment, in particular the washing compartment, a fan for ventilating the functional compartment, in particular the washing compartment, and/or a door opener for opening a door of the functional compartment, in particular the washing compartment.

The active drying system can have, for example, a fan, a heating element and a sorption column in which the water-absorbent material is received. The active drying system can also be an exhaust air drying system. In this case, the active drying system comprises a fan which is adapted to dissipate moist air from the functional compartment, in particular the washing compartment, and to suck in cold, dry ambient air again. The door opener is adapted to open the door of the functional compartment, in particular the washing compartment, by a crack so air laden with moisture can escape from the functional compartment, in particular the washing compartment. Cold, dry air then flows into the functional compartment, in particular the washing compartment, and removes moisture from the functional compartment, in particular the washing compartment. The drying system can also comprise an actively cooled condensation surface, a heat exchanger or heat exchanger tube.

According to a further embodiment, the first insulation element prevents heat transfer from the functional compartment, in particular the washing compartment, to the second insulation element.

This prevents the second insulation element from drawing heat from the functional compartment, in particular the washing compartment. The energy efficiency of the functional compartment, in particular the washing compartment, is improved hereby. The second insulation element is preferably adapted to convert vibrations into heat. The first insulation element can also be suitable for converting vibrations into heat.

According to a further embodiment, the second insulation element has a higher density than the first insulation element.

The first insulation element preferably has a mass density or density between 5 and 150 kg/m³, preferably between 50 and 120 kg/m³, more preferably between 70 and 100 kg/m³. The mass density or density of the second insulation element is preferably greater than 1,000 kg/m³.

According to a further embodiment, the second insulation element is made from a bitumen material, in particular from a metal- and/stone-filled bitumen material, or from a plastic material, in particular from a metal- and/or stone-filled plastic material.

The bitumen material or the plastic material can have dispersed metal powder or stone dust. The second insulation element is preferably panel- or mat-like. For example, the second insulation element can also be made from a butyl material. Alternatively, the second insulation element can be a metal plate, in particular a steel plate.

According to a further embodiment, a separation later is arranged between the first insulation element and the second insulation element in order to separate the first insulation from the second insulation element non-destructively.

Reutilization of the first insulation element and the second insulation element after the end of the service life of household appliance, in particular the household dishwasher, is possible hereby. The first insulation element and the second insulation element can be separated from each other in particular without residue. Alternatively, the insulation elements can also be non-detachably connected to each other.

Further possible implementations of the invention also comprise combinations, which are not explicitly mentioned, of features or embodiments described above or hereinafter in respect of the exemplary embodiments. The person skilled in the art will also add individual aspects as improvements or additions to the respective basic form of the invention.

Further advantageous embodiments and aspects of the invention are the subject matter of the subclaims and of the exemplary embodiments of the invention described below. The invention will be explained in more detail hereinafter on the basis of the preferred embodiments with reference to the accompanying figures.

In the drawings:

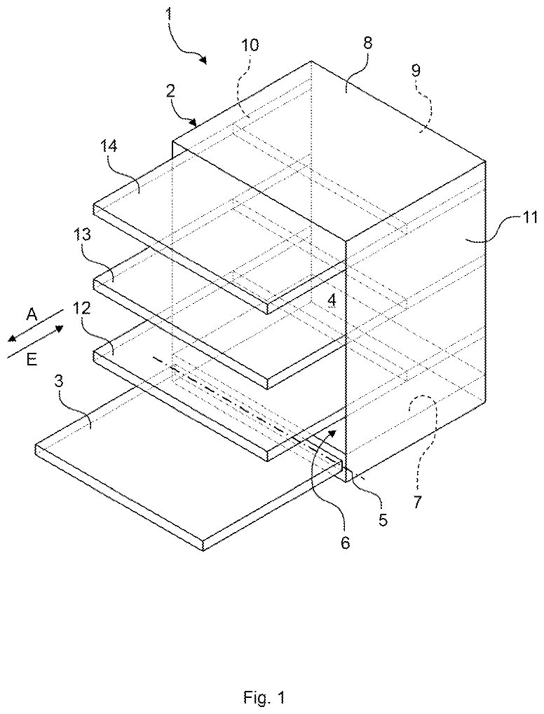

FIG. 1 shows a schematic perspective view of an embodiment of a household appliance in the form of a household dishwasher;

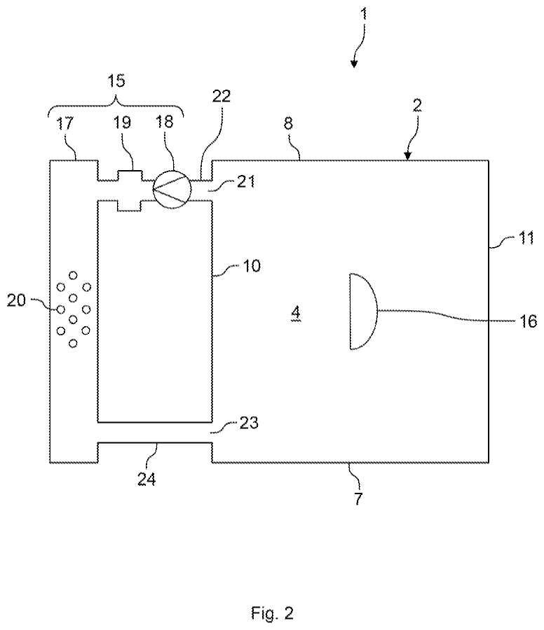

FIG. 2 shows a schematic sectional view of the household dishwasher according to FIG. 1;

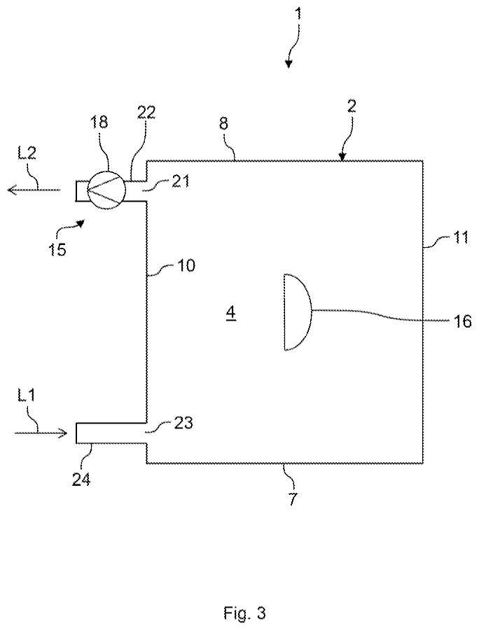

FIG. 3 shows a schematic sectional view of a further embodiment of a household dishwasher;

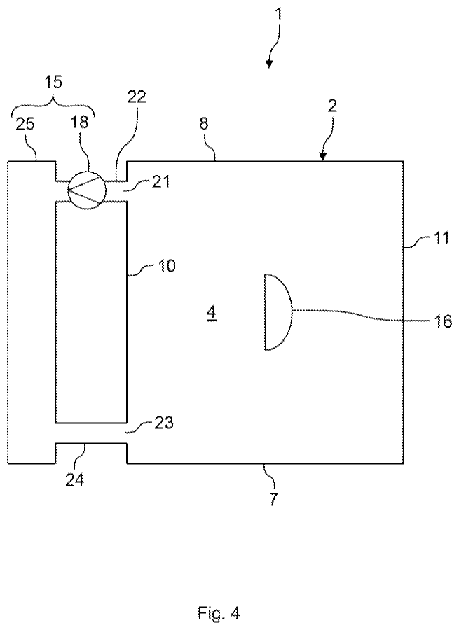

FIG. 4 shows a schematic sectional view of a further embodiment of a household dishwasher;

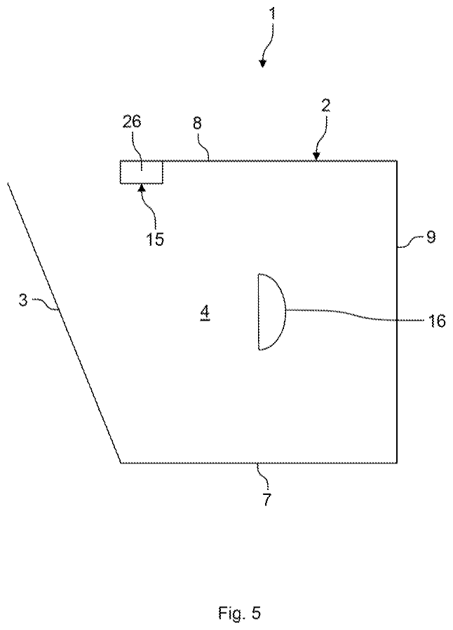

FIG. 5 shows a schematic sectional view of a further embodiment of a household dishwasher;

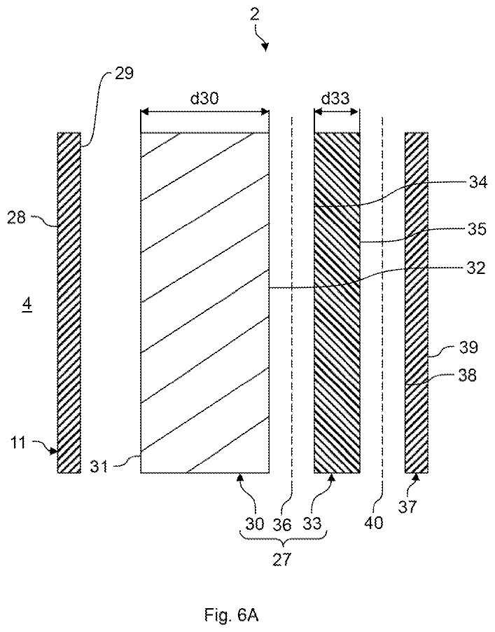

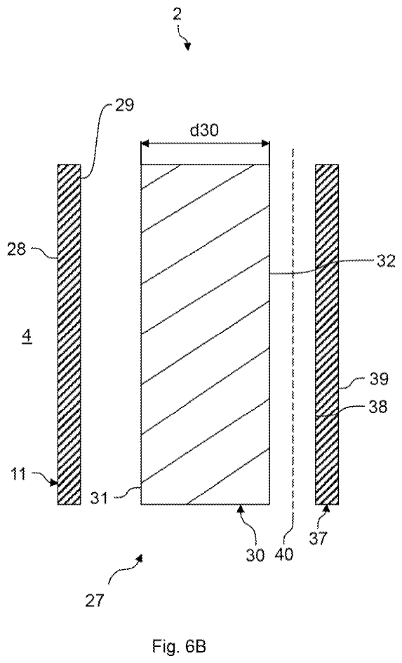

FIG. 6A shows a schematic part sectional view of an embodiment of a washing compartment for the household dishwasher according to FIGS. 1 to 5 in an exploded view;

FIG. 6B shows a schematic part sectional view of a further embodiment of a washing compartment for the household dishwasher according to FIGS. 1 to 5 in an exploded view;

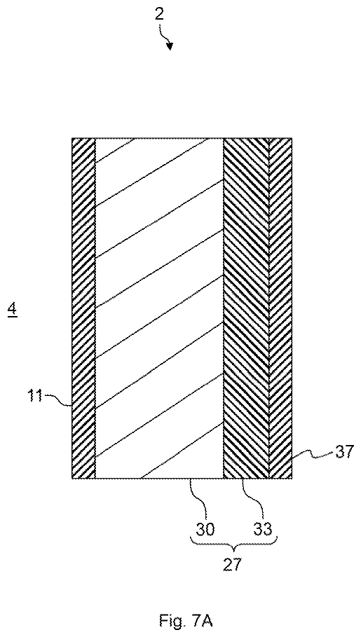

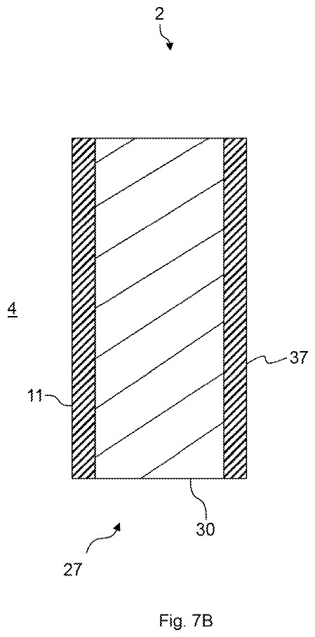

FIG. 7A shows a further schematic part sectional view of the washing compartment according to FIG. 6A; and

FIG. 7B shows a further schematic part sectional view of the washing compartment according to FIG. 6B.

Identical elements or those with the same function have been provided with the same reference characters in the figures unless stated otherwise.

FIG. 1 shows a schematic perspective view of an embodiment of a household appliance 1 in the form of a household dishwasher. The household dishwasher 1 comprises a functional compartment in the form of a washing compartment 2, which can be sealed by a door 3, in particular so as to be water-tight. For this, a sealing mechanism can be provided between the door 3 and the washing compartment 2. The washing compartment 2 is preferably cuboidal. The washing compartment 2 can be arranged in a housing of the household dishwasher 1. The dishwasher 2 and the door 3 can form a dishwasher interior 4 for washing items for washing.

FIG. 1 shows the door 3 in its open position. The door 3 can be closed or opened by swiveling about a swivel axis 5 provided on a lower end of the door 3. A loading opening 6 of the washing compartment 2 can be closed or opened with the aid of the door 3. The washing compartment 2 has a base 7, a ceiling 8 arranged opposite the base 7, a back wall 9 arranged opposite the closed door 3, and two mutually opposing side walls 10. 11. The base 7, the ceiling 8, the back wall 9 and the side walls 10, 11 can be made, for example from a stainless steel sheet. Alternatively, the base 7 can be made from a plastic material.

The household dishwasher 1 also has at least one holder 12 to 14 for items for washing. Preferably, a plurality of, for example three, holders 12 to 14 for items for washing can be provided, wherein the holder 12 for items for washing can be a lower holder for items for washing or a lower rack, the holder 13 for items for washing an upper holder for items for washing or a top basket and the holder 14 for items for washing can be a cutlery drawer. As FIG. 1 also shows, the holders 12 to 14 for items for washing are arranged on top of each other in the washing compartment 2. Each holder 12 to 14 for items for washing can optionally be moved into the washing compartment 2 or out of it. In particular, each holder 12 to 14 for items for washing can be pushed into or moved into the washing compartment 2 in an insertion direction E (arrow) and can be withdrawn or moved out of the washing compartment 2 in a withdrawal direction A (arrow) counter to the insertion direction E (arrow).

The inventive household appliance 1 can in general be a household dishwasher, a household washing machine or a household tumble dryer. Depending on the type of household appliance, the functional compartment can be a washing compartment, a tub or a washing drum. A household washing machine of this kind is known, for example, from document EP 2 049 723 A1, whereas a household tumble dryer is known from document DE 33 45 303 A1. The content in this regard of these documents, cited by way of example, is hereby incorporated as a subject matter of the present description.

FIG. 2 shows a schematic sectional view of the household dishwasher 1. The household dishwasher 1 comprises an active drying system 15 for active drying of items for washing 16 received in the washing compartment 2. The items for washing 16 can comprise, for example, crockery, cutlery, cookware, saucepans or the like. The items for washing 16 are received in the dishwasher interior 4. The items for washing 16 can be received in one of the holders 12 to 14 for items for washing, which are not shown in FIG. 2.

The active drying system 15 comprises a sorption column 17, a fan 18 and a heating element 19. The sorption column 17 contains as a drying agent a water-absorbent material 20, for example zeolite. The water-absorbent material 20 can, in particular, be reversibly dehydrated. This means that the water-absorbent material 20 can give off absorbed moisture again under the effect of heat. The water-absorbent material 20 can be in granular form, for example, and be absorbed in the sorption column 17.

The washing compartment 2 comprises at an upper region of the side wall 10 an outlet opening 21, which is connected by a pipe 22 to the active drying system 15. The fan 18 and the heating element 19 are arranged in or on the pipe 22. The fan 18 is positioned downstream of the outlet opening 21, the heating element 19 is positioned downstream of the fan 18 and the sorption column 17 is positioned downstream of the heating element 19. Furthermore, the side wall 10 comprises an inlet opening 23, which is fluidically connected via a pipe 24 to the active drying system 15, in particular to the sorption column 17. The dishwasher interior 4 is fluidically connected to the active drying system 15 with the aid of the pipes 22, 24, therefore.

In a drying step, air with a high humidity is drawn from the washing compartment 2 with the aid of the fan 18 and conveyed through the sorption column. The water-absorbent material 20 received in the sorption column 17 absorbs the humidity. The air dried in this way is then fed to the washing compartment 2 again in a circuit via the pipe 24. The dried air can then absorb moisture again in the dishwasher interior 4 and feed it to the sorption column 17. The items for washing 16 are dried, therefore.

The volume of water stored in the water-absorbent material 20 can be released again in the sorption column 17 in a regeneration process, in other words in a desorption, by heating the water-absorbent material 20. For this, air is conveyed with the aid of the fan 18 through the sorption column 17, which has been heated to very high temperatures by the heating element 19. As a result, the water stored in the water-absorbent material 20 exits as hot steam and is returned into the washing compartment 2.

FIG. 3 shows a schematic sectional view of a further embodiment of a household dishwasher 1. The household dishwasher 1 according to FIG. 3 differs from the household dishwasher 1 according to FIGS. 1 and 2 by way of an alternative embodiment of the active drying system 15. In this embodiment of the active drying system 15, the system is designed as an exhaust air drying system.

The active drying system 15 comprises a fan 18, as explained above, a pipe 22 connected to the outlet opening 21 of the washing container 2, and a pipe 24 connected to the inlet opening 23 of the washing container 2. In a drying step, dry, cool ambient air L1 is sucked into washing compartment 2 with the aid of the fan 18. The cool ambient air L1 is warmed by the warmed items for washing 16. The ambient air L1 warmed by the items for washing 16 absorbs water from the items for washing 16, and the ambient air L1 laden with the water is blown out of the washing compartment 2 as exhaust air L2 with the aid of the fan 18.

FIG. 4 shows a schematic sectional view of a further embodiment of a household dishwasher 1. The household dishwasher 1 according to FIG. 4 differs from the household dishwasher 1 according to FIG. 3 only in that the active drying system 15 in the case of the household dishwasher 1 according to FIG. 1 is designed as a circulating air drying system and not as an exhaust air drying system.

In addition to the fan 18 mentioned above, the active drying system 15 comprises for this an external condensation compartment 25. The condensation compartment 25 is fluidically connected to the washing compartment 2 with the aid of the pipes 22, 24. With the aid of the fan 18 the moist air is blown from the washing compartment 2 into the condensation compartment 25. There the air cools, releases the moisture to the condensation compartment 25 and is conveyed into the washing compartment 2 again. The cooled air is warmed there on the warm items for washing 16 and absorbs moisture from the items for washing 16.

FIG. 5 shows a schematic sectional view of a further embodiment of a household dishwasher 1. The household dishwasher 1 according to FIG. 5 differs from the embodiments of the household dishwasher 1 according to FIGS. 1 to 4 by way of a further alternative embodiment of the active drying system 15. In this embodiment of the household dishwasher 1, the active drying system 15 comprises a door opener 26 for opening the door 3 by a crack.

In a drying step, the door 3 can be opened by a crack. After opening the door 3 by a crack, warm, moist air escapes from the washing compartment 2. Cool ambient air flows from below into the washing compartment 2 through the open door 3. The cool ambient air is warmed by the warm items for washing 16 and absorbs water from the items for washing 16.

The embodiments of the active drying system explained above may also be combined with each other as desired. Thus, for example, the embodiment of the household dishwasher 1 according to FIGS. 1 and 2 can be combined with the embodiment of the household dishwasher 1 according to FIG. 5, so, in addition to the sorption column 17, the fan 18 and the heating element 19, the active drying system 15 also has the door opener 26.

FIGS. 6A and 7A each show a schematic part sectional view of the washing compartment 2. FIG. 6A shows an exploded view. FIGS. 6A and 7A show, in particular, only a detail of the side wall 11 of the washing compartment 2. The household dishwasher 1 comprises an insulation arrangement 27 for thermal and/or acoustic insulation of the washing compartment 2. The insulation arrangement 27 can be provided on the side walls 10, 11, the back wall 9 or the ceiling 8 and/or the door 3. The insulation arrangement 27 can also be provided on the base 7. The washing compartment 2 can be partially or fully received in the insulation arrangement 27, so the insulation arrangement 27 at least partially envelops or encases the washing compartment 2.

The insulation arrangement 27 is provided externally on the washing compartment 2. In this case, “externally” is taken to mean facing away from the dishwasher interior 4. The side wall 11 has an inner side 28 facing the dishwasher interior 4, and an outer side 29 facing the dishwasher interior 4. The insulation arrangement 27 is provided on the outer side 29.

The insulation arrangement 27 comprises a first insulation element 30 provided externally on the washing compartment 2 for thermal and/or acoustic insulation of the washing compartment 2. The first insulation element 30 can also be referred to as the thermal or/and acoustic insulation element. The first insulation element 30 is preferably made from a foamed plastic material, in particular from a foamed polyurethane. Preferably, the first insulation element 30 has an open-pore structure, so the first insulation element 30 is compressible. The first insulation element 30 comprises a first surface 31 facing the outer side 29 of the side wall 11, and a second surface 32 facing away from the first surface 31. The first insulation element 30 has viscoelastic properties.

In a cured and/or crosslinked state, the plastic material used for the first insulation element 30 preferably has adhesive properties, so the first insulation element 30 adheres to the washing compartment 2 with the first surface 31 facing the washing compartment 2 and can be non-destructively separated from it. This means that the first insulation element 30 can be fastened without adhesive to the washing compartment 2 and can also be removed from it again without residue. The application of the adhesive for connecting the first insulation element 30 to the washing compartment 2 can be omitted as a result. Furthermore, at the end of the service life of the household dishwasher 1, the first insulation element 30 and the washing compartment 2 can be separated from each other without residue for easy reutilization thereof. Slight residues from the first insulation element 30 can also remain on the side wall 11 when the first insulation element 30 is detached from the side wall 11. These residues can be easily rubbed off, however.

The first insulation element 30 has a thickness d30 of preferably 5 to 50 mm, more preferably of 10 to 45 mm, more preferably of 15 to 40 mm, more preferably of 20 to 35 mm, more preferably of 25 to 30 mm. A density ρ30 of the first insulation element 30 is preferably between 5 and 150 kg/m³, particularly preferably 50 to 120 kg/m³, more preferably 70 to 100 kg/m³. A specific heat conductivity λ30 of the first insulation element 30 is preferably less than 0.1 W/(m*K), preferably less than 0.05 W/(m*K). The first insulation element 30 preferably also has a specific heat capacity c30 of less than 2,000 J/(kg*K), preferably a specific heat capacity of less than 1,600 J/(kg*K), more preferably of less than 1,400 J/(kg*K).

The insulation arrangement 27 also has a second insulation element 33. The second insulation element 33 can also be referred to as an acoustic insulation element. The second insulation element 33 is used, in particular, as a mass layer and improves the acoustic properties of the insulation arrangement 27. The second insulation element 33 is arranged on the first insulation element 30, so the first insulation element 30 is arranged between the washing compartment 2 and the second insulation element 33. The second insulation element 33 comprises a first surface 34 facing the first insulation element 30, and a second surface 35 facing away from the first surface 34. A thickness d33 of the second insulation element 33 is preferably less than the thickness d30 of the first insulation element 30. For example, the thickness d33 is 1 to 10 mm, preferably 1 to 8 mm, more preferably 1 to 5 mm, more preferably 1 to 3 mm.

The first insulation element 30 is, as mentioned above, also suitable, in particular, for damping vibrations. A loss factor of the plastic material of the first insulation element 30 is high and matched to the use in the household dishwasher 1. In the present case a “loss factor” with physical vibrations of differing nature is taken to mean the ratio of the loss-affected imaginary part to the loss-free real part of a complex variable. The loss factor of the plastic material of the first insulation element 30 at 20° C. is, in particular, greater than 0.2, preferably greater than 0.4. Furthermore, the hysteresis loss according to the IFD method (“hysteresis loss—IFD”) to ASTM D3574 is preferably greater than 15%, preferably greater than 20%, in particular greater than 30%, and the recovery time to ASTM D3574 is preferably greater than 2 s, preferably greater than 4, in particular greater than 5 s. In part the vibrations are also passed on to the second insulation element 33. The second insulation element 33 in the bond of the insulation arrangement 27 substantially provides a mass per unit area due to its high density.

In particular, the first insulation element 30 prevents a heat transfer from the washing compartment 2 to the second insulation element 33. The second insulation element 33 cannot draw any heat from the washing compartment 2 hereby. As a result, the energy efficiency of the household dishwasher 1 is improved. Vibrations of the washing compartment 2 are converted into heat in the second insulation element 33 but also in the first insulation element 30.

The second insulation element 33 preferably has a much higher density than the first insulation element 30. The second insulation element 33 is preferably made from a bitumen material, in particular from a metal- and/or stone-filled bitumen material, or from a plastic material, in particular from a metal and/or stone-filled plastic material. For example, the second insulation element 33 can be made from a butyl material. The second insulation element 33 is, in particular, panel- or mat-like. The second insulation element 33 can also be a metal sheet, in particular a steel sheet.

The second insulation element 33 is used for sound deadening the washing compartment 2 or damping vibrations of the washing compartment 2. The second insulation element 33 preferably has an optimally high loss factor. The loss factor of the material of the second insulation element 33 at 20° C. is preferably greater than 0.08, more preferably greater than 0.15. A density ρ33 of the second insulation element 33 is preferably greater than 1,000 kg/m³.

The second insulation element 33 is connected to the first insulation element 30 in such a way that the second insulation element 33 and the first insulation element 30 may be separated from each other non-destructively and without residue. Reutilization of the materials of the first insulation element 30 and the second insulation element 33 is easily possible hereby. For example, the first insulation element 30, owing to the preferably adhesive properties of its second surface 32, can be connected to the first surface 34 of the second insulation element 33. Optionally, a separation layer 36 can be arranged between the first insulation element 30 and the second insulation element 33. The separation layer 36 can be part of the insulation arrangement 27. The separation layer 36 can be, for example, a wax layer, a film layer or a plurality of films laid one above the other. The second insulation element 33 can also be non-detachably connected to the first insulation element 30, however.

An outer paneling 37 can be externally provided on the second insulation element 33. The outer paneling 37 can comprise a first surface 38 facing the second insulation element 33 and a second surface 39 facing away from the first surface 38. The outer paneling 37 can be part of a housing of the household dishwasher 1. The outer paneling 37 can be, for example, a steel sheet. The outer paneling 37 can either lie loose on the second insulation element 33 or can be detachably connected thereto. For this, an optional separation layer 40 can be provided between the second insulation element 33 and the outer paneling 37. The separation layer 40 can have an identical construction to the separation layer 36.

FIG. 6B shows a schematic part sectional view of a further embodiment of the washing compartment 2 in an exploded view. FIG. 7B shows a further part sectional view of the washing compartment 2. The washing compartment 2 according to FIGS. 6B and 7B differs from the washing compartment 2 of FIGS. 6A and 7A only in that the insulation arrangement 27 only has the first insulation element 30. The second insulation element 33 is, in particular, not provided.

The combination of the insulation arrangement 27 with an active drying system 15 as mentioned above, enables the full energy potential of the household dishwasher 1 to be exploited. The use of the insulation arrangement 27 in combination with an active drying system 15 is advantageous in particular with household dishwashers 1 with an energy consumption of less than 1.2 kWh/c, in particular of less than 1.0 kWh/c, in particular of less than 0.8 kWh/c, in particular of less than 0.7 kWh/c or also in particular of less than 0.6 kWh/c.

The transfer of heat into the second insulation element 33 can be considerably reduced owing to the construction of the insulation arrangement 27 with the first insulation element 30 arranged between the washing compartment 2 and the second insulation element 33. The energy consumption of the household dishwasher 1 is reduced hereby. The maximum effectiveness of the active drying system 16 can be exploited. The first insulation element 30 can completely enclose the washing compartment 2 externally. When using a hot water connection the heat from the supplied water can be retained in the washing compartment 2 for longer. The washing compartment 2 cools down more slowly owing to the improved thermal insulation of the washing compartment 2. As a result, the temperature remains high for longer during the washing process and improves the washing performance. The effectiveness of the improved thermal insulation can be achieved in all programs. An energy saving can be attained for the performance of a complete washing program. An energy saving can also be attained in the heating phase. A greater energy transfer takes place in subsequent heating baths.

Although the present invention has been described with reference to exemplary embodiments, it can be modified in a wide variety of ways.

### LIST OF REFERENCE CHARACTERS

1 household appliance; household dishwasher
2 functional compartment; washing compartment
3 door
4 dishwasher interior
5 swivel axis
6 loading opening
7 base
8 ceiling
9 back wall
10 side wall
11 side wall
12 holder for items for washing
13 holder for items for washing
14 holder for items for washing
15 active drying system
16 items; items for washing
17 sorption column
18 fan
19 heating element
20 water-absorbent material
21 outlet opening
22 pipe
23 inlet opening
24 pipe
25 condensation compartment
26 door opener
27 insulation arrangement
28 inner side
29 outer side
30 first insulation element
31 surface
32 surface
33 second insulation element
34 surface
35 surface
36 separation layer
37 outer paneling
38 surface
39 surface
40 separation layer
A withdrawal direction (arrow)
c30 heat capacity
d30 thickness
d33 thickness
E insertion direction (arrow)
L1 ambient air
L2 exhaust air
λ30 heat conductivity
ρ30 density
ρ33 density

1-10. (canceled)

11. A household appliance, comprising:
a functional compartment;
an insulation arrangement arranged externally on the functional compartment for thermal and/or acoustic insulation of the functional compartment, said insulation arrangement including a first insulation element made as a single piece from a plastic material which is selected such that a surface of the first insulation element in facing relation to the functional compartment adheres to the functional compartment and is separable therefrom in a non-destructive manner; and
an active drying system operably connected to the functional compartment for active drying of an item received in the functional compartment.

12. The household appliance of claim 11, constructed in the form of a household dishwasher.

13. The household appliance of claim 11, wherein the functional compartment is a washing compartment.

14. The household appliance of claim 11, wherein the plastic material has an adhesive property in a cured and/or cross-linked state.

15. The household appliance of claim 11, wherein the plastic material is a polyurethane.

16. The household appliance of claim 11, wherein the plastic material is a foamed polyurethane.

17. The household appliance of claim 11, wherein the plastic material has a viscoelastic property.

18. The household appliance of claim 11, wherein the household appliance has an energy consumption of less than 1.2 kWh/c.

19. The household appliance of claim 11, wherein the household appliance has an energy consumption of less than 1.0 kWh/c.

20. The household appliance of claim 11, wherein the household appliance has an energy consumption of less than 0.8 kWh/c.

21. The household appliance of claim 11, wherein the household appliance has an energy consumption of less than 0.7 kWh/c or less than 0.6 kWh/c.

22. The household appliance of claim 11, wherein the active drying system includes at least one of a water-absorbent material for absorbing moisture in the functional compartment, a fan for ventilating the functional compartment, and a door opener for opening a door of the functional compartment.

23. The household appliance of claim 11, wherein the water-absorbent material is zeolite.

24. The household appliance of claim 11, wherein the insulation arrangement includes a second insulation element, with the first insulation element arranged between the functional compartment and the second insulation element.

25. The household appliance of claim 24, wherein the first insulation element is configured to prevent heat transfer from the functional compartment to the second insulation element.

26. The household appliance of claim 24, wherein the second insulation element has a density which is higher than a density of the first insulation element.

27. The household appliance of claim 24, wherein the second insulation element is made from a bitumen material or from a plastic material.

28. The household appliance of claim 27, wherein the bitumen material is a metal-filled bitumen material and/or stone-filled bitumen material.

29. The household appliance of claim 27, wherein the plastic material is a metal-filled plastic material and/or stone-filled plastic material.

30. The household appliance of claim 24, further comprising a separation layer arranged between the first insulation element and the second insulation element in order to non-destructively separate the first insulation element from the second insulation element.
